(19) United States
(12) Patent Application Publication
(10) Pub. No.: US 2013/0095362 A1
(43) Pub. Date: Apr. 18, 2013

(54) VANADIUM FLOW CELL

(71) Applicant: Deeya Energy, Inc., Fremont, CA (US)

(72) Inventors: Majid KESHAVARZ, Pleasanton, CA (US); Ge Zu, San Jose, CA (US)

(73) Assignee: Deeya Energy, Inc., Fremont, CA (US)

(21) Appl. No.: 13/651,230

(22) Filed: Oct. 12, 2012

Related U.S. Application Data
(60) Provisional application No. 61/547,643, filed on Oct. 14, 2011.

(51) Int. Cl. H01M 2/36; H01M 4/36

(52) U.S. Cl. 429/105; 205/50

(57) ABSTRACT

A Vanadium chemistry flow cell battery system is described. Methods of forming the electrolyte, a formulation for the electrolyte, and a flow system utilizing the electrolyte are disclosed. Production of electrolytes can include a combination of chemical reduction and electrochemical reduction.

### REFERENCE TO RELATED APPLICATIONS

The present invention claims priority to U.S. Provisional Application No. 61/547,643, entitled “Vanadium Flow Cell”, filed on Oct. 14, 2011, the contents of which are herein incorporated by reference in its entirety.

### BACKGROUND

1. Field of the Invention

Embodiments disclosed herein generally relate to Vanadium based flow cell batteries.

2. Description of the Relevant Art

There is an increasing demand for novel and innovative electric power storage systems. Redox flow cell batteries have become an attractive means for such energy storage systems. In certain applications, a redox flow cell battery may include one or more redox flow cells. Each of the redox flow cells may include positive and negative electrodes disposed in separate half-cell compartments. The two half-cells may be separated by a porous or ion-selective membrane, through which ions are transferred during a redox reaction. Electrolytes (anolyte and catholyte) are flowed through the half-cells as the redox reaction occurs, often with an external pumping system. In this manner, the membrane in a redox flow cell battery operates in an aqueous electrolyte environment.

In order to provide a consistent supply of energy, it is important that many of the components of the redox flow cell battery system are performing properly. Redox flow cell battery performance, for example, may change based on parameters such as the state of charge, temperature, electrolyte level, concentration of electrolyte and fault conditions such as leaks, pump problems, and power supply failure for powering electronics.

Vanadium based flow cell system have been proposed for some time. However, there have been many challenges in developing a Vanadium based system that would be economically feasible. These challenges include, for example, the high cost of the Vanadium electrolyte, the high cost of appropriate membranes, the low energy density of dilute electrolyte, thermal management, impurity levels in the Vanadium, inconsistent performance, stack leakage, membrane performance such as fouling, electrode performance such as delamination and oxidation, rebalance cell technologies, and system monitoring and operation.

One group has investigated vanadium/vanadium electrolytes in H₂SO₄. In that effort, V₂O₅+V₂O₃+H₂SO₄ yields VOSO₄. An electrochemical reduction of V₂O₅+H₂SO₄ can also yield VOSO₄. However, preparation of the electrolyte has proved difficult and impractical. Another group has tried a mixture of H2SO4 and HCl by dissolving VOSO₄ in HCl. However, again the electrolyte has proved to be expensive and and impractical to prepare sulfate free formulation.

Therefore, there is a need for better redox flow cell battery systems.

### SUMMARY

Embodiments of the present invention provide a vanadium based flow cell system. A method for providing an electrolytic solution according to the present invention includes chemically reducing an acidic solution/suspension of V5+ to form a reduced solution and electrochemically reducing the reduced solution to form an electrolyte.

A flow cell battery system according to some embodiments of the present invention includes a positive vanadium electrolyte; a negative vanadium electrolyte; and a stack having a plurality of cells, each cell formed between two electrodes and having a positive cell receiving the positive vanadium electrolyte and a negative cell receiving the negative vanadium electrolyte separated by a porous membrane.

These and other embodiments of the invention are further described below with respect to the following figures.

### BRIEF DESCRIPTION OF THE DRAWINGS

FIG. 1 shows a vanadium based redox flow cell according to some embodiments of the present invention in a system.

FIG. 2 illustrates a method of providing a vanadium electrolyte.

FIG. 3A illustrates production of a balanced electrolyte according to some embodiments of the present invention.

FIG. 3B illustrates production of electrolytes according to some embodiments of the present invention.

Where possible in the figures, elements having the same function have the same designation.

### DETAILED DESCRIPTION

It is to be understood that the present invention is not limited to particular devices or methods, which may, of course, vary. It is also to be understood that the terminology used herein is for the purpose of describing particular embodiments only, and is not intended to be limiting.

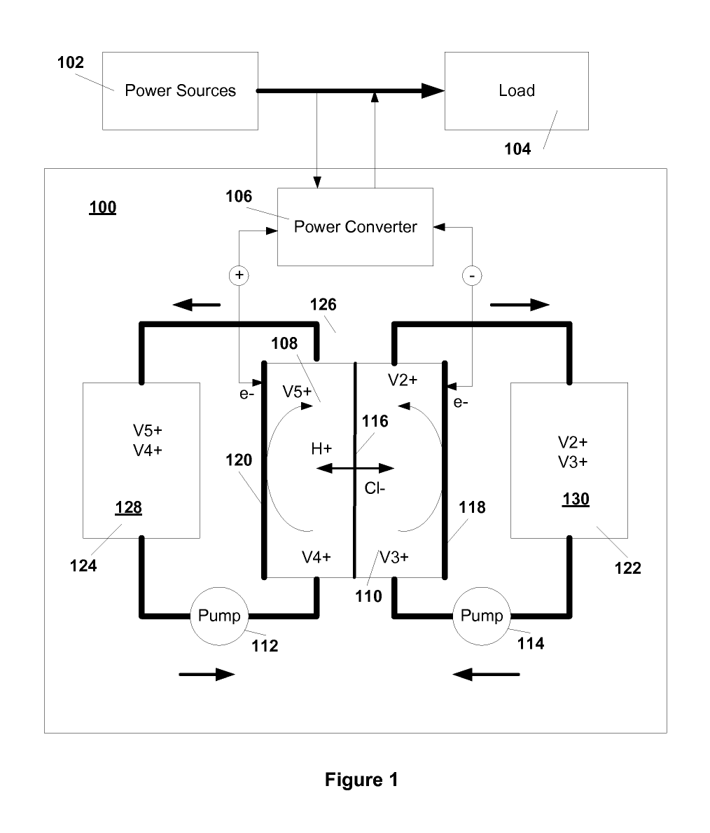

FIG. 1 illustrates a vanadium based flow system 100 according to some embodiments of the present invention. As shown in FIG. 1, system 100 is coupled between power sources 102 and a load 104. Power sources 102 can represent any source of power, including an AC power grid, renewable power generators (solar, wind, hydro, etc.), fuel generators, or any other source of power. Load 104 can represent any user of power, for example a power grid, building, or any other load devices.

As shown in FIG. 1, redox flow cell system 100 includes redox flow cell stack 126. Flow cell stack 126 illustrates a single cell, which includes two half-cells 108 and 110 separated by a membrane 116, but in most embodiments is a collection of multiple individual cells. An electrolyte 128 is flowed through half-cell 108 and an electrolyte 130 is flowed through half-cell 110. Half-cells 108 and 110 include electrodes 120 and 118, respectively, in contact with electrolytes 128 and 130, respectively, such that redox reactions occur at the surface of the electrodes 120 or 118. In some embodiments, multiple redox flow cells 126 may be electrically coupled (e.g., stacked) either in series to achieve higher voltage or in parallel in order to achieve higher current. The stacked cells 126 are collectively referred to as a battery stack and flow cell battery can refer to a single cell or battery stack. As shown in FIG. 1, electrodes 120 and 118 are coupled across power converter 106, through which electrolytes 128 and 130 are either charged or discharged.

When filled with electrolyte, half-cell 110 of redox flow cell 100 contains anolyte 130 and the other half-cell 108 contains catholyte 128, the anolyte and catholyte being collectively referred to as electrolytes. Reactant electrolytes may be stored in separate reservoirs 124 and 122, respectively, and dispensed into half-cells 108 and 110 via conduits coupled to cell inlet/outlet (I/O) ports. In some embodiments, an external pumping system is used to transport the electrolytes to and from the redox flow cell.

At least one electrode 120 and 118 in each half-cell 108 and 110 provides a surface on which the redox reaction takes place and from which charge is transferred. Redox flow cell system 100 operates by changing the oxidation state of its constituents during charging or discharging. The two half-cells 108 and 110 are connected in series by the conductive electrolytes, one for anodic reaction and the other for cathodic reaction. In operation (e.g., during charge or discharge), electrolytes 126 and 124 are flowed through half-cells 108 and 110.

Electrolyte is flowed through half-cell 108 from holding tank 124, the positive electrolyte, by a pump 112. Electrolyte is flowed through half-cell 110 from holding tank 122, the negative electrolyte, through pump 114. Holding tank 124, during operation, holds an electrolyte formed from V⁵⁺ and V⁴⁺ species while holding tank 122 holds an electrolyte formed from V² and V³⁺ species. As discussed below, starting from a balanced electrolyte (a 1:1 ratio of V3+ and V4+) an initial charging results in the V³⁻ in tank 122 being converted to V⁴⁺ and the V⁴⁺ in tank 122 being converted to V³⁺. After the initial charge, then charging of flow cell 100 results in conversion of V⁴⁺ to V⁵⁺ in the positive electrolyte stored in tank 124 and conversion of V³⁺ to V²⁺ in the negative electrolyte stored in tank 122. Discharge of flow cell 100 results in conversion of V⁵⁺ to V⁴⁻ in tank 124 and V²⁺ to V³⁻ in tank 122.

Positive ions or negative ions pass through permeable membrane 116, which separates the two half-cells 108 and 110, as the redox flow cell 100 charges or discharges. Reactant electrolytes are flowed through half-cells 108 and 110, as necessary, in a controlled manner to supply electrical power or be charged through power converter 106. Suitable membrane materials for membrane 106 include, but are not limited to, materials that absorb moisture and expand when placed in an aqueous environment. In some embodiments, membrane 106 may comprise sheets of woven or non-woven plastic with active ion exchange materials such as resins or functionalities embedded either in a heterogeneous (such as co-extrusion) or homogeneous (such as radiation grafting) way. In some embodiments, membrane 106 may be a porous membrane having high voltaic efficiency Ev and high coulombic efficiency and may be designed to limit mass transfer through the membrane to a minimum while still facilitating ionic transfer. In some embodiments, membrane 106 may be made from a polyolefin material or fluorinated polymers and may have a specified thickness and pore diameter. A manufacturer having the capability to manufacture these membranes, and other membranes consistent with embodiments disclosed, is Daramic Microporous Products, L.P., N. Community House Rd., Suite 35, Charlotte, N.C. 28277. In certain embodiments, membrane 106 may be a nonselective microporous plastic separator also manufactured by Daramic Microporous Products L.P. A flow cell formed from such a membrane is disclosed in U.S. Published Patent App. No. 2010/0003586, filed on Jul. 1, 2008, which is incorporated herein by reference.

In general, membrane 116 can be any material that forms a barrier between fluids, for example between electrochemical half-cells 108 and 110 (e.g., an anode compartment and a cathode compartment). Exemplary membranes may be selectively permeable, and may include ion-selective membranes. Exemplary membranes may include one or more layers, wherein each layer exhibits a selective permeability for certain species (e.g., ions), and/or effects the passage of certain species.

As shown in FIG. 1, the electrolytic reactions for the Vanadium chemistry involve V³⁺+e⁻==>V²⁺ in half-cell 110 and VO₂⁺(V⁵⁺)+2H⁻+e⁻==>VO²⁺(V⁴⁺)+H₂O. The open circuit voltage of each cell in stack 126 is then 1.25V, (−0.25 V from half-cell 110 and 1.00V from half-cell 108). As shown in FIG. 1, ions H⁺ and Cl⁻ (or sulfate) may traverse membrane 116 during the reaction.

In some embodiments, multiple redox flow cells may be stacked to form a redox flow cell battery system. Construction of a flow cell stack battery system is described in U.S. patent application Ser. No. 12/577,134, entitled “Common Module Stack Component Design” filed on Oct. 9, 2009, which is incorporated herein by reference.

Further descriptions of details of redox flow cell battery systems can be found in the following U.S. Patent Applications, all of which are incorporated herein by reference: U.S. patent application Ser. No. 11/674,101, entitled “Apparatus and Methods of Determination of State of Charge in a Redox Flow Battery”, filed on Feb. 12, 2007; U.S. application Ser. No. 12/074,110, entitled “Battery Charger”, filed on Feb. 28, 2008; U.S. patent application Ser. No. 12/217,059, entitled “Redox Flow Cell,” filed on Jul. 1, 2008; U.S. patent application Ser. No. 12/576,235, entitled “Magnetic Current Collector” filed on Oct. 8, 2009; U.S. patent application Ser. No. 12/576,242, entitled “Method and Apparatus for Determining State of Charge of a Battery” filed on Oct. 9, 2009; U.S. patent application Ser. No. 12/577,127, entitled “Thermal Control of a Flow Cell Battery” filed on Oct. 9, 2009; U.S. patent application Ser. No. 12/577,131, entitled “Methods for Bonding Porous Flexible Membranes Using Solvent” filed on Oct. 9, 2009; U.S. patent application Ser. No. 12/577,134, entitled “Common Module Stack Component Design” filed on Oct. 9, 2009; U.S. patent application Ser. No. 12/577,147, entitled “Level Sensor for Conductive Liquids” filed on Oct. 9, 2009; U.S. patent application Ser. No. 12/790,793 entitled “Control System for a Flow Cell Battery”, filed May 28, 2010; U.S. patent application Ser. No. 12/790,794 entitled “Hydrogen Chlorine Level Detector”, filed May 28, 2010; U.S. patent application Ser. No. 12/790,749 entitled “Optical Leak Detection Sensor”, filed May 28, 2010; U.S. patent application Ser. No. 12/790,783 entitled “Buck-Boost Control Circuit”, filed May 28, 2010; and U.S. patent application Ser. No. 12/790,753 entitled “Flow Cell Rebalancing”, filed May 28, 2010.

Embodiments of the invention disclosed herein attempt to solve many of the challenges involved with utilizing a Vanadium chemistry in a redox flow cell. As such, this disclosure is separated into three sections: I. Preparation of the Electrolyte; II. Formulation of the Electrolyte; and III. The flow cell battery system.

### I. Electrolyte Preparation

Vanadium electrolyte can be very expensive to prepare. In previous efforts, VOSO₄ is utilized as a starting material for preparation of the electrolyte. However, VOSO₄ is very expensive to procure and VOCl₂ is not commercially available. The correct oxidation state of vanadium, as starting material, for vanadium redox flow battery is V⁴⁺ for positive side and V³⁺ for negative side or a 1:1 mixture of V⁴⁺ and V³⁺ for both sides, which is often referred to as V^{3.5+} or “balanced electrolyte.” In accordance with aspects of the present invention, the electrolyte material can be formed from a V⁵⁺ compound such as V₂O₅. V₂O₅ is much less expensive to procure than is VOSO₄, and is much more readily available. The electrolyte is then formed of lower oxidation states of the V⁵⁺ of V₂O₅.

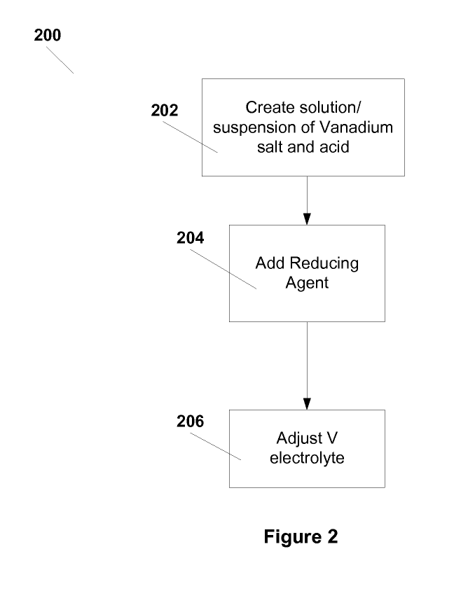

In accordance with the present invention, a vanadium electrolyte is formed from a source of V⁵⁺ by adding a reducing agent and an acid. A method of producing a vanadium based electrolyte is illustrated in procedure 200 shown in FIG. 2. As shown in FIG. 2, step 202 includes creating a solution and/or suspension of Vanadium and acid. In general, the solution or suspension includes V⁵⁺. V⁵⁺ can be obtained, for example, with the compounds V₂O₅, MVO₃, or M₃VO₄, where M can be NH₄₊, Na⁺, K⁺, or some other cations, although some of these compounds may leave impurities and undesired ions in the electrolyte. The acid can be H₂SO₄, HCl, H₃PO₄, CH₃SO₃H, or a mixture of these acids. In some embodiments, the acid is a mixture of H₂SO₄ and HCl. In some cases, only HCl is utilized. Previously, H₂SO₄ has been utilized as the acid in the electrolyte. However, a combination of HCl and H₂SO₄ or all HCl can be utilized in some embodiments.

In step 204, a reducing agent is added to the Vanadium containing acid solution formed in step 202. The general reaction is given by

V⁵⁺+Reducing Agent+Acid======>V⁽⁵⁻ⁿ⁾⁺,

where n=1, 2, or 3. The reducing agent can be an organic reducing agent or an inorganic reducing agent. Organic reducing agents include one carbon reagents, two carbon reagents, three carbon reagents, and four or higher carbon reagents.

One carbon reducing agents include methanol, formaldehyde, formic acid, and nitrogen containing functional groups like acetamide or sulfur containing functional groups like methyl mercaptane or phosphorous functional groups. For example, one such reaction, for example, starts with methanol as follows:

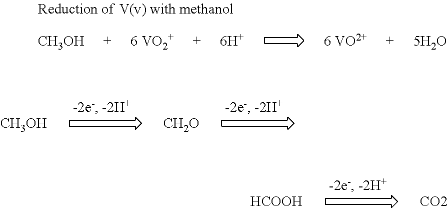

In this reaction, methanol to formaldehyde to formic acid provides the reduction of the V⁵⁺, resulting in the emission of CO₂. The electrons go to reducing the vanadium charge state. The reaction can also begin with formaldehyde or formic acid or any mixture of them.

Two carbon reducing agents include ethanol, acetaldehyde, acetic acid, ethylene glycol, glycol aldehyde, oxaldehyde, glycolic acid, glyoxalic acid, oxalic acid, nitrogen containing functional groups such as 2-aminoethanol, sulfur containing functional groups like ethylene dithiol. One such reaction starts with ethylene glycol and ends again with CO2:

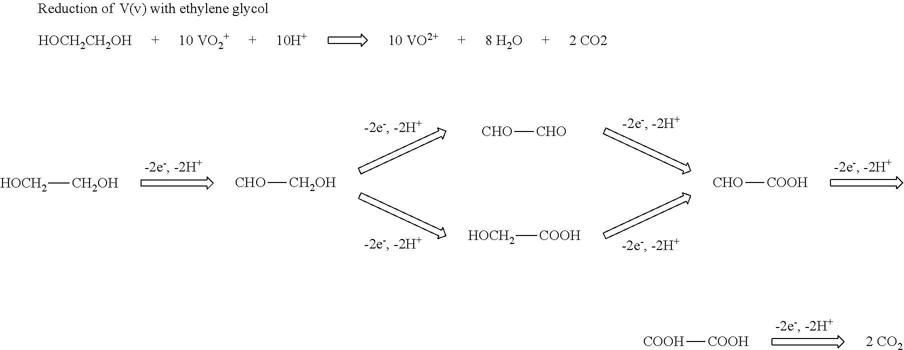

Ethylene glycol C₂H₄(OH)₂ is very useful as a reducing agent since it provide 10 electrons and final product is gaseous carbon dioxide.

Three carbon reducing agents can also be used. Such reducing agents include 1-propanol, 2-proponal, 1,2-propanediol, 1,3-propanedial, glycerol, propanal, acetone, propionic acid and any combination of hydroxyl, carbonyl, carboxylic acid, nitrogen containing functional groups, sulfur containing functional groups, and phosphourous functional groups. Of these, glycerol is a great source of electrons that work like ethylene glycol. The only by-product is gaseous carbon dioxide and glycerol provides 14 electrons to the reduction reaction. The chemical reduction utilizing glycerol can be described as:

HOCH₂—HCOH—H₂COH+14VO₂+14H⁺=→14VO²⁺+11H₂O+3CO₂.

Four or more carbon organic molecules with any combination of hydroxyl, carbonyl, carboxylic acid, nitrogen containing functional groups, sulfur containing functional groups, or phosphorous functional groups can be utilized. For example, sugar (e.g. glucose or other sugar) can be utilized.

The result in each of the organic reducing agents is to reduce the V⁵⁺ to V⁽⁵⁻ⁿ⁾⁺, n=1, 2, 3, (mainly n=1) without addition of high concentrations of impurity compounds in the resulting electrolyte. Many of these reducing agents (e.g., methanol glycerol, sugar, ethylene glycol) provide a large number of electrons to the reducing reaction while producing carbon dioxide, hydrogen and water as byproducts.

In addition to the organic reagents described above, inorganic reducing agents can also be utilized. Inorganic reducing agents can include, for example, sulfur, and sulfur dioxide. Any sulfide, sulfite, or thiosulfate salt can also be utilized. Sulfur compounds work great, especially if sulfate salt is desired in the final formulation. However, the resulting solution may have higher concentrations of sulfuric acid at completion of the process. Sulfide salts can be utilized, resulting in the added ions appearing in the solution at the end of the process. Additionally, vanadium metal can be utilized. Vanadium metal can easily give up four electrons to form V⁴⁻.

Secondary reducing agents, which can be added in small quantities, can include any phosphorous acid, hypophophorous acid, oxalic acid and their related salts. Any nitrogen based reducing agent can be utilized. Further, metals can be included, for example Alkali metals, alkaline earth metals, and some transition metals like Zn and Fe.

The reduction process outlined in step 204 of FIG. 2 can be assisted with heating or may proceed at room temperature. Reagent is added until the vanadium ion concentration is reduced as far as desired. In step 206, the acidity of the resulting vanadium electrolyte can be adjusted by the addition of water or of additional acid.

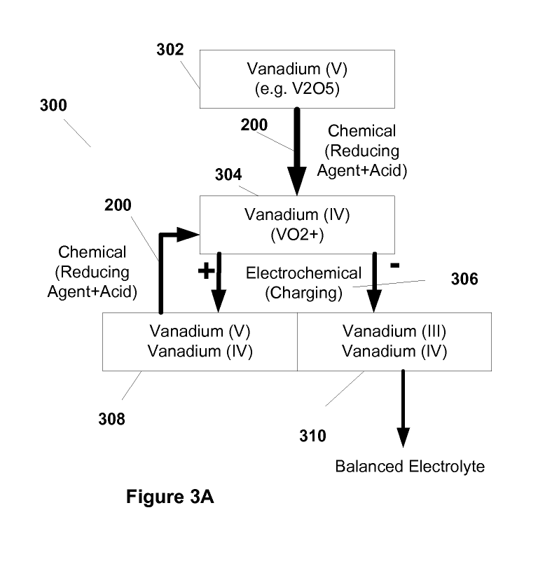

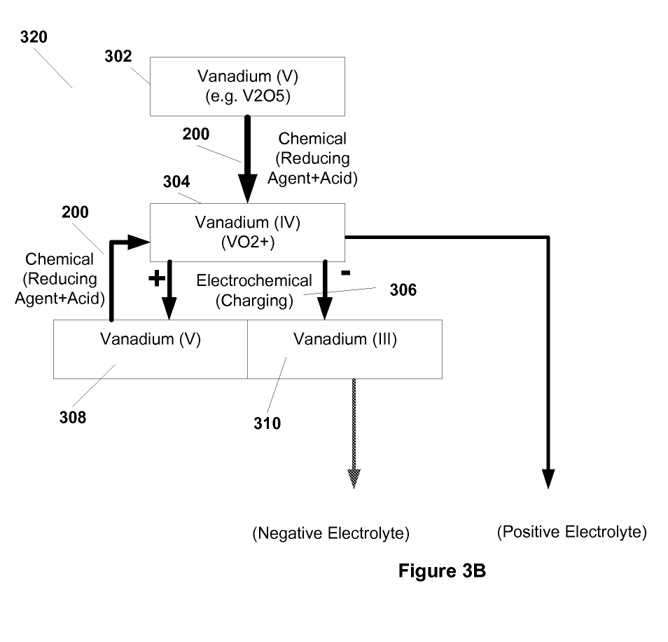

FIG. 3A illustrates a procedure 300 of producing vanadium based electrolyte according to some embodiments of the present invention. In first state 302, a starting preparation of V⁵⁺ (e.g., an acidic solution/suspension of V₂O₅) is prepared as discussed above. A chemical reducing reaction such as that illustrated in procedure 200 discussed above is performed to provide an acidic solution 304 of V⁴⁺, which is prepared from the reduction of V₂O₅ as discussed above. As discussed above, solution 304 may contain any reduction of V⁵⁺, e.g. V⁽⁵⁻ⁿ⁾⁺, however for purposes of explanation solution 304 can be an acidic solution of primarily V⁴⁺.

Solution 304 is then utilized to fill the holding tanks of an electrochemical cell. The electrochemical cell can be, for example, similar to flow cell system 100 illustrated in FIG. 1. In some embodiments, procedure 300 can utilize a flow cell 100 as illustrated in FIG. 1 that includes a single electrochemical cell. In some embodiments, a stack 126 that includes individual multiple cells can be utilized in procedure 300.

In some embodiments, the electrochemical cell can be a photochemical cell such as the rebalance cell described in U.S. patent application Ser. No. 12/790,753 entitled “Flow Cell Rebalancing”, filed May 28, 2010, which is incorporated herein by reference. Such a cell can be utilized to generate low-valence vanadium species from V⁵⁺. The rebalance cell is a redox reaction cell with two electrodes on either end and a membrane between the two electrodes that provides a negative side and a positive side. The positive side includes an optical source that assists generating the HCl solution. On the negative side of the rebalance cell, V^{5|} can be reduced to V² or the reduction can be stopped at V^{4|} or V^{3|} oxidation states. On the positive side, HCl will be oxidized electrochemically to Cl₂ gas or, with the addition of H₂, recombined in the photochemical chamber to regenerate HCl.

In step 306, the electrochemical cell containing solution 304 is charged. Electrochemical charging can proceed to a nominal state of charge. This results in solution 308, for example in tank 124 of flow cell 100, containing V⁵⁺ and solution 310, for example in tank 122 of flow cell 100, containing V³⁺. In some embodiments, the reaction may be stopped when solution 310 achieves a balanced electrolyte of 1:1 ratio of V³⁺ and V⁴⁺ (e.g., a SOC of 50%). As illustrated in FIG. 3A, solution 310 can then be used as a balanced electrolyte in both the positive and negative sides of a flow cell battery such as flow cell 100 illustrated in FIG. 1. As illustrated in FIG. 3A, electrochemical charging 306 results in a solution 308 from the positive side of the electrochemical cell that includes V⁵⁺ and a solution 310 from the negative side of the electrochemical cell that includes V³⁺. Solution 308 can undergo further chemical reduction in process 200 and then be included in solution 304. As is further shown in FIG. 3B illustrates a procedure 320 for producing electrolyte according to some embodiments of the present invention. Procedure 320 is similar to procedure 300 illustrated in FIG. 3A. However, in procedure 320, electrochemical charging reaction 306 is allowed to proceed to a higher state of charge, in some cases close to 100%. In that case, solution 310 can be utilized as the negative electrolyte and solution 304 utilized as the positive electrolyte in a flow cell battery.

Regardless as to whether procedure 300 outlined in FIG. 3A or procedure 320 illustrated in FIG. 3B is utilized, the electrolyte solution on the positive side of a flow cell battery will yield V⁵⁺ on charging and the negative side of the flow cell battery will yield V²⁺ on charging. On discharge, the electrolytes release their stored energy and return to the uncharged state. Further, solution 302 can be formed utilizing any combination of acids. For example, solution 302 can be formed of HCl and be sulfur free (i.e. not include H2SO4), can be a mixture of HCl and H₂SO₄, or can be formed of H₂SO₄. The resulting electrolyte can, in some cases, be sulfur free.

### II. Formulation of the Electrolyte

In some embodiments, all chloride (sulfate free) electrolyte has been prepared with 2.5 Molar VO²⁺ in 4 N HCl. The total acid molarity can be from 1 to 9 molar, for example 1-6 molar. The vanadium concentration can be between 0.5 and 3.5 M VO2+, for example 1.5 M, 2.5 M, or 3M VOCl₂. Higher concentration of vanadium have been prepared (e.g., 3.0 M vanadium in HCl) and utilized in a flow cell such as cell 100. Mixed electrolyte have also been prepared in HCl and sulfuric acid and utilized in a flow cell such as cell 100. All chloride (no sulfate or sulfate free electrolyte) is the most soluble and stable electrolytes at higher and lower temperatures, as sulfate anion reduces the solubility of vanadium species. All chloride solutions can be heated up 65 C can be kept at 65 C for a long time, where as sulfate based solutions precipitate at 40 C. Different ratios of sulfate and chloride can be prepared. The total acid molarity can be from 1 to 9 molar, for example 1-3 molar. The vanadium concentration can be between 1 and 3.5 M VOSO₄.

A catalyst can also be added to the electrolyte. In some embodiments, 5 ppm of Bi³⁺ for example Bismuth chloride or bismuth oxide can be added. This concentration can range from 1 ppm to 100 ppm. Other catalysts that can be utilized include lead, indium, tin, antimony, and thallium.

In one example preparation of solution 304, a 400 L polyethylene reaction vessel equipped with a Teflon-coated mechanical stirrer and a Teflon-coated thermocouple was charged with DI water (22 L), glycerol (5.0 L) and 12 M HCl (229 L). V₂O₅ (75.0 kg) was added in six installments over 2.5 hours while the heterogeneous mixture was self-heated to 60-70° C. The progress of the reaction was monitored by absorption spectroscopy (Ultraviolet-Visible) at different time intervals. After four hours of stirring the blue solution was filtered through five and one micron filters respectively. The concentration of V⁴⁺ was measured by UV-VIS spectroscopy to be 3.0 M and the acid concentration was measured by titration to be 4 M. The volume of the solution was 275 L.

In a second example preparation of solution 304, A 400 L polyethylene reaction vessel equipped with a Teflon-coated mechanical stirrer and a Teflon-coated thermocouple was charged with DI water (69 L), glycerol (3.05 L) and 12 M HCl (167 L). V₂O₅ (45.0 kg) was added in three installments over 2.0 hours while the heterogeneous mixture was self-heated to 60-70° C. The progress of the reaction was monitored by absorption spectroscopy (Ultraviolet-Visible) at different time intervals. After 3.5 hours of stirring, DI water (100 L) and 12 M HCl (50 L) were added to the mixture. The blue solution was filtered through five and one micron filters respectively. The concentration of V⁴⁺ was measured by UV-VIS spectroscopy to be 1.25 M and the acid concentration was measured by titration to be 4 M. The volume of the solution was 400 L.

From either of these example preparations of solution 304, preparation of electrolyte as illustrated in FIGS. 3A and 3B can be undertaken. The electrochemical process was conducted at constant current mode.

### III. The Flow Cell System

The flow cell system 100 is generally described in the applications incorporated by reference herein. Although those systems are described in the context of a Fe/Cr chemistry, the flow cell system 100 operates equally well with the vanadium chemistry described herein. Tanks 122 and 124 can each be 200 liter tanks and the electrolyte formed from 1.15 M VOSO₄/4.0 M HCl. Stack 126 includes 22 individual cells with a general reaction area of 2250 cm². Stack 126 can utilize Nippon 3 mm high density felt, Daramic membranes, Graphite foil bipolar plates, Ti current collectors. There is no rebalance cell and no plating procedure. A 150 A or higher charge can be utilized.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for providing an electrolyte solution, comprising:
chemically reducing an acidic solution/suspension of V⁵⁺ to form a reduced solution; and
electrochemically reducing the reduced solution to form an electrolyte.

2. The method of claim 1, wherein chemically reducing includes
providing an aqueous acidic solution/suspension of V⁵⁺;
reducing the V⁵⁺ to obtain V⁽⁵⁻ⁿ⁾⁺ where n=1, 2, or 3; and
adjusting the acidity of the solution to achieve the reduced solution.

3. The method of claim 2, wherein the aqueous acidic solution includes a mixture of H₂SO₄ and HCl.

4. The method of claim 2, wherein the concentration of H₂SO₄ in the aqueous acidic solution is substantially 0%.

5. The method of claim 2, wherein the concentration of HCl in the aqueous acidic solution is substantially 0%.

6. The method of claim 1, wherein reducing the V⁵⁺ includes adding an organic reducing agent.

7. The method of claim 6, wherein the organic reducing agent is one or more of a group consisting of methanol, formaldehyde, formic acid, ethanol, acetaldehyde, acetic acid, ethylene glycol, glycol aldehyde, oxaldehyde, glycolic acid, glycolic acid, glyoxalic acid, oxalic acid, 1-propanol, 2-propanol, 1,2-propanediol, 1,3-propanediol, glycerol, propanal, acetone, and propionic acid.

8. The method of claim 6, wherein CO₂ is emitted during the reduction process.

9. The method of claim 1, wherein reducing the V⁵⁺ includes adding an inorganic reducing agent.

10. The method of claim 9, wherein the inorganic reducing agent is one or more of a group consisting of sulfur, sulfur dioxide, sulfurous acid, sulfide salts, sulfite salts, thiosulfate salts, and vanadium metal.

11. The method of claim 1, wherein electrochemically reducing includes
filling storage tanks of an electrochemical cell with the reduced solution; and
charging the electrochemical cell to obtain an electrolyte solution.

12. The method of claim 1, wherein the electrochemical cell is an electrophotochemical cell.

13. The method of claim 11, wherein the electrolyte solution includes V³⁺ and V⁴⁺.

14. The method of claim 11, wherein the electrolyte solution is a positive electrolyte solution and the reduced solution is a negative electrolyte solution.

15. The method of claim 11, further including adding hydrogen gas to a positive side of the electrochemical cell to form HCl.

16. The method of claim 2, wherein adjusting the acidity of the solution results in a solution of approximately 2.5 M M VOCl₂ in about 4 M HCl.

17. The method of claim 2, wherein adjusting the acidity of the solution results in a solution of VO²⁺ in HCl, where VO²⁺ concentration can be 1 to 3.5 molar and acid concentration can be 1 to 8 molar.

18. The method of claim 2, further including addition of a catalyst to the acidic aqueous solution.

19. The method of claim 18, wherein the catalyst is about 1 ppm to about 100 ppm of Bismuth(III) salts.

20. The method of claim 18, wherein the catalyst is chosen from a group consisting of lead, indium, tin, antimony, and thallium.

21. A flow cell battery system, comprising
a positive vanadium electrolyte;
a negative vanadium electrolyte;
a stack having a plurality of cells, each cell formed between two electrodes and having a positive cell receiving the positive vanadium electrolyte and a negative cell receiving the negative vanadium electrolyte separated by a porous membrane.

22. The system of claim 21, wherein the positive electrode and the negative electrode are VO²⁺ in a solution of HCl.

23. The system of claim 21, wherein the positive electrode and the negative electrode are 2.5 M VO Cl₂ in 4.0M HCl.

24. The system of claim 21, wherein the positive electrode and the negative electrode are 3.0 M VO Cl₂ in 3.0M HCl.

25. The system of claim 21, wherein the positive electrode and the negative electrode are VO²⁻ in a solution of HCl and H₂SO₄.

26. The system of claim 21, wherein the positive electrode and the negative electrode are VOSO₄ in a solution of H₂SO₄.
